(19) United States
(12) Patent Application Publication
(10) Pub. No.: US 2019/0048837 A1
(43) Pub. Date: Feb. 14, 2019

(54) Fuel Pump For A Fuel Injection System

(71) Applicant: Continental Automotive GmbH, Hannover (DE)

(72) Inventors: Yury Mikhaylov, Landshut (DE); Yavuz Kurt, Roding (DE)

(73) Assignee: Continental Automotive GmbH, Hannover (DE)

(21) Appl. No.: 16/058,221

(22) Filed: Aug. 8, 2018

(30) Foreign Application Priority Data
Aug. 9, 2017 (DE) 10 2017 213 891.2

(51) Int. Cl. F02M 55/04; F02M 59/02; F04B 9/04; F04B 11/00

(52) U.S. Cl. CPC F02M 55/04; F04B 11/0016; F04B 9/042; F02M 59/025

(57) ABSTRACT

Various embodiments may include a high-pressure fuel pump for applying high pressure to a fuel in a fuel injection system comprising: a pump housing with a housing bore arranged between a first end region and a second end region, a pump piston movable in translation along a movement axis of the housing bore during operation, and an outer wall region extending parallel to the housing bore between the first end region and the second end region; and a damper arrangement with a damper housing, wherein the damper housing and the outer wall region collectively delimit an overall damping volume. The damper housing has a housing depth extending tangentially with respect to the outer wall region along a depth axis and a housing length extending radially with respect to the movement axis away from the outer wall region along a longitudinal axis. The housing length is greater than the housing depth.

### CROSS-REFERENCE TO RELATED APPLICATIONS

This application claims priority to DE Application No. 10 2017 213 891.2 filed Aug. 9, 2017, the contents of which are hereby incorporated by reference in their entirety.

### TECHNICAL FIELD

The present disclosure relates to pumps. Various embodiments may include a high-pressure fuel pump for applying high pressure to a fuel in a fuel injection system.

### BACKGROUND

High-pressure fuel pumps are used, in fuel injection systems by means of which fuel is injected into combustion chambers of an internal combustion engine, to apply a high pressure to the fuel, wherein the pressure lies for example in a range from 150 bar-400 bar in gasoline internal combustion engines and in a range from 1500 bar-2500 bar in diesel internal combustion engines. The higher the pressure which can be generated in the respective fuel, the lower the emissions which arise during the combustion of the fuel in the combustion chamber, this being advantageous in particular against the background of a reduction in emissions being desired to an ever greater extent.

To achieve the high pressures in the respective fuel, the high-pressure fuel pump is typically a piston pump, wherein a pump piston performs a translational movement and in so doing periodically compresses and relieves the pressure on the fuel. The thus non-uniform delivery of such a piston pump leads to fluctuations in the volume flow in a low-pressure region of the high-pressure fuel pump, which fluctuations are associated with pressure fluctuations in the entire fuel injection system. As a consequence of these fluctuations, filling losses can occur in the high-pressure fuel pump, as a result of which correct dosing of the fuel quantity required in the combustion chamber cannot be ensured. The pressure pulsations that arise furthermore cause pump components, and for example feed lines to the high-pressure fuel pump, to vibrate, which vibrations can cause undesired noises or, in the worst case, even damage to various parts.

A damper arrangement is therefore normally provided in the low-pressure region of the high-pressure fuel pump, which damper arrangement operates as a hydraulic accumulator and evens out the fluctuations in the volume flow and thus reduces the pressure pulsations that arise. For this purpose, deformable elements are installed which separate a gas volume from fuel. If the pressure in the low-pressure region of the high-pressure fuel pump increases, said elements deform, wherein, for example, the gas volume is compressed and space is created for the superfluous liquid of the fuel. If the pressure falls again at a later point in time, the gas expands again, and the stored liquid of the fuel is thus released again.

It has hitherto been known for such damper arrangements to be attached to an end region of the pump housing of the high-pressure fuel pump. For this purpose, it is necessary to provide a pump housing which, at the end region provides sufficient structural space for a damper arrangement of said type. This need undesirably limits the flexibility in the provision of the pump housing, for example in the case of high-grade steel rods with small diameters being used.

### SUMMARY

The teachings of the present disclosure may provide a high-pressure fuel pump that is improved in this respect. For example, in some embodiments a high-pressure fuel pump (10) for applying high pressure to a fuel in a fuel injection system includes: a pump housing (12) with a housing bore (20) which is arranged between a first end region (14) of the pump housing (12) and a second end region (16) of the pump housing (12) and in which there is guided a pump piston (22) which moves in translational fashion along a movement axis (24) during operation, and having an outer wall region (32) which extends parallel to the housing bore (20) between the first end region (14) and the second end region (16); a damper arrangement (34) with a damper housing (36) which, together with the outer wall region (32) of the pump housing (12), delimits an overall damping volume (54); wherein the damper housing (36) has a housing depth (38) which extends tangentially with respect to the outer wall region (32) along a depth axis (40), wherein the damper housing (36) has a housing length (42) which extends, radially with respect to the movement axis (24), away from the outer wall region (32) along a longitudinal axis (44), wherein the housing length (42) is greater than the housing depth (38).

In some embodiments, the housing length (42) is at least twice the size of the housing depth (38).

In some embodiments, the housing length (42), extending away from the outer wall region (32), of the damper housing (36) is at least equal in size to a diameter d of the pump housing (12) perpendicular to the movement axis (24), wherein the pump housing (12) is in particular formed from a bar material (46) with a diameter d<4 cm.

In some embodiments, the pump housing (12) has a recess (48) in the outer wall region (32), wherein the damper housing (36) is arranged on the outer wall region (32) so as to close off the recess (48) in a flush manner, wherein a recess volume (50) defined by the recess (48) and a damper housing volume (52) defined by the damper housing (36) together define the overall damping volume (54), wherein the recess volume (50) in particular amounts to at most ⅓ of the overall damping volume (54).

In some embodiments, a damper capsule (56) is arranged in the damper housing (36), which damper capsule has a capsule height (58), extending tangentially with respect to the outer wall region (32), and a capsule length (60), extending radially with respect to the movement axis (24), wherein the capsule length (60) is greater than the capsule height (58).

In some embodiments, the damper capsule (56) is arranged in the damper housing (36) such that the damper capsule (56) extends into the recess volume (50).

In some embodiments, in the damper housing (36), there is arranged at least one spacer sleeve (68) for spacing the damper capsule (56) apart from a damper housing wall (70), wherein the spacer sleeve (68) extends into the recess volume (50).

In some embodiments, the damper capsule (56) and/or the spacer sleeve (68) are fastened exclusively in the damper housing (36), in particular by means of a force fit.

In some embodiments, the damper housing (36) forms at least one connector geometry (74) for the fastening of a fluid connector (76), wherein the connector geometry (74) extends in particular parallel to the longitudinal axis (44) of the damper housing (36).

In some embodiments, the damper housing (36) is formed as a unipartite deep-drawn part (72).

### BRIEF DESCRIPTION OF THE DRAWINGS

Various embodiments of the teachings herein are explained in more detail below by means of the appended drawings, in which:

FIG. 1 is a perspective illustration of a high-pressure fuel pump with a pump housing to which a damper arrangement is fastened;

FIG. 2 is a cross-sectional illustration of the high-pressure fuel pump from FIG. 1 through the pump housing and the damper arrangement;

FIG. 3 is an enlarged cross-sectional illustration corresponding to FIG. 2 in the region of the damper arrangement;

FIG. 4 is an enlarged cross-sectional illustration corresponding to FIG. 2 and FIG. 3 of only the damper arrangement;

FIG. 5 is a perspective illustration of a spacer sleeve which is arranged in the damper arrangement as per FIG. 3 and FIG. 4;

FIG. 6 is a perspective illustration of a first embodiment of a damper housing for the damper arrangement from FIG. 3 and FIG. 4;

FIG. 7 shows a plan view of a second embodiment of a damper housing for the damper arrangement from FIG. 3 and FIG. 4; and

FIG. 8 is a cross-sectional illustration through the damper housing from FIG. 7 with a fluid connector fastened thereto.

### DETAILED DESCRIPTION

In some embodiments, a high-pressure fuel pump applies high pressure to a fuel in a fuel injection system. The pump may include a pump housing with a housing bore which is arranged between a first end region of the pump housing and a second end region of the pump housing and in which there is guided a pump piston which moves in translational fashion along a movement axis during operation. The pump housing may include an outer wall region which extends parallel to the housing bore between the first end region and the second end region. The high-pressure fuel pump furthermore comprises a damper arrangement with a damper housing which, together with the outer wall region of the pump housing, delimits an overall damping volume. The damper housing has a housing depth which extends tangentially with respect to the outer wall region along a depth axis, and furthermore has a housing length which extends, radially with respect to the movement axis, away from the outer wall region along a longitudinal axis. Here, the housing length is greater than the housing depth.

In some embodiments, the damper arrangement is arranged laterally on the pump housing of the high-pressure fuel pump, by contrast to hitherto known high-pressure fuel pumps, in the case of which the damper arrangements are mounted on an upper end of the pump housing. In this way, the pump housing can be manufactured from a rigid material with as small a diameter as possible. In this way, the high-pressure fuel pump can remain competitive and also require less structural space for the high-pressure fuel pump during use, because the core component of the high-pressure fuel pump, specifically the pump housing, can be reduced in diameter overall. Since, above a certain diameter of the bar material for the pump housing, the structural space for the damper arrangement, which has hitherto been mounted on the upper end of the high-pressure fuel pump, is no longer sufficient, the damper arrangement is mounted laterally on the pump housing. To achieve a sufficient damping action, the damper arrangement must however provide a predetermined volume. To permit this, the damper arrangement extends away from the pump housing into the surroundings. This yields a housing length along the longitudinal axis which extends radially with respect to the movement axis from the outer wall region of the pump housing, which housing length is considerably greater than the housing depth, which extends along a depth axis tangentially with respect to the outer wall region.

In some embodiments, the damper arrangement is mounted, with its length oriented radially, on the pump housing, wherein the longitudinal axis of the damper housing extends at least approximately at right angles to the pump axis, that is to say to the movement axis of the pump piston. The lateral arrangement of the damper arrangement on the pump housing offers greater flexibility or variability with regard to the orientation of an electrical connector plug. In the case of known high-pressure fuel pumps, an electrical plug must be oriented only laterally. The downward inclination is in most cases not possible, because there are normally numerous obstructive contours situated here. This normally yields an angle range for the orientation of only approximately 180°. In the case of the proposed high-pressure fuel pump and the lateral arrangement of the damper arrangement, however, it is possible for electrical components, such as for example a coil and associated electrical plug, to be oriented in an angle range of 360° on the pump housing.

In some embodiments, the damper housing has a fastening flange formation by means of which the damper housing can be fastened to the pump housing. For example, it is thus possible for the damper housing to be welded to the outer wall region of the pump housing.

If the damper housing is arranged laterally on the pump housing, advantages also arise for the weld seam for the fastening of the damper housing to the pump housing. Damper arrangements have hitherto been known which are formed for example as damper covers which are connected directly to the pump housing, in most cases by means of welding. During the operation of the high-pressure fuel pump, a damper cover of said type is subjected to a force owing to the pressure prevailing in the interior of the high-pressure fuel pump, in particular in the case of pressure peaks. The area exposed to said pressure is generally the diameter of the attachment cross section between a damper cover of said type and the pump housing. Owing to the damper arrangement now being attached laterally on a longitudinal side, the length of such a weld seam and also the hydraulically effective area can be considerably reduced. This yields a considerably lower hydraulic load and thus, overall, greater robustness of the high-pressure fuel pump. The shorter length of the weld seam also has the advantage that, in this way, the cycle time during the assembly of the high-pressure fuel pump can be reduced, and thus assembly costs can be saved. Furthermore, the risk of welding defects or shrinkage cavities is reduced, which likewise reduces the risk of leakage during the operation of the high-pressure fuel pump.

In some embodiments, the housing length is at least twice the size of the housing depth of the damper housing. In some embodiments, the damper arrangement is very narrow and can be fastened in a flexible manner to the outer wall region of the pump housing. In some embodiments, the housing length, extending away from the outer housing wall, of the damper housing may be at least equal in size to a diameter d of the pump housing perpendicular to the movement axis. That is to say, the diameter d of the pump housing in relation to the damper arrangement is very small and takes up only little structural space in the installed state. The pump housing is in this case may be formed from a bar material with a diameter d<4 cm.

The required diameter d for the bar material for the production of the pump housing greatly influences the production price of the pump housing. As a result of the damper arrangement being attached laterally and longitudinally to the pump housing, the required diameter d of the bar material can be considerably reduced, which results in reduced production costs for the pump housing.

In some embodiments, the pump housing has a recess in the outer wall region, wherein the damper housing is arranged on the outer wall region so as to close off the recess in a flush manner. Here, a recess volume defined by the recess and a damper housing volume defined by the damper housing together define the overall damping volume. Through the recess volume, the damper arrangement may be shorter along the longitudinal axis, because a part of the pump housing can already contribute to the damping of the overall volume. In this way, structural space of the high-pressure fuel pump as a whole may be saved. Various bores may extend inward into the pump housing from the recess. Therefore, in this case, the recess performs multiple functions, firstly the provision of a further part of the overall damper volume, but also furthermore a connection to further parts of the high-pressure fuel pump.

In some embodiments, the recess volume amounts to at most 1/3 of the overall damping volume. In this way, the main part of the overall damping volume is arranged in the damper housing, and the pump housing can be manufactured from a particularly thin bar material, that is to say with a very small diameter d.

If a part of the damper arrangement projects laterally into the pump housing, structural space for the high-pressure fuel pump as a whole may be reduced. This may keep connecting bores, for example between the damper arrangement and an inlet valve, or to a drive region of the pump piston, relatively short. This may yield improved damping of pressure peaks and also shorter machining times for said connecting bores during the production of the pump housing, which in turn results in lower production costs for the pump housing as a whole. In some embodiments, cross sections may be very large, whereby, for example, the connecting bores can have large bore diameters or be designed as elongated holes. This, too, contributes to improved damping characteristics of the damper arrangement.

In some embodiments, walls of the recess and walls of the damper housing may be arranged in alignment with respect to one another, such that the recess can be closed in a flush manner by attachment of the damper housing to the pump housing.

In some embodiments, a damper capsule may be arranged in the damper housing, which damper capsule has a capsule height, extending tangentially with respect to the outer wall region, and a capsule length, extending radially with respect to the movement axis, wherein the capsule length is greater than the capsule height. In this way, the damper capsule may extend laterally away from the outer wall region of the pump housing.

In some embodiments, the damper capsule may be constructed from two welded-together membranes which, between them, enclose a gas volume. During operation, the membranes are deformable, because the gas volume is compressible. In some embodiments, the damper capsule is substantially circular and rotationally symmetrical about a capsule vertical axis. The capsule length accordingly corresponds to a cross-sectional length of a cross section of the damper capsule along the capsule longitudinal axis perpendicular to the movement axis. The damper capsule may be arranged in the damper housing such that the capsule longitudinal axis of the damper capsule runs along the capsule length perpendicular to the movement axis.

In some embodiments, the damper capsule is arranged in the damper housing such that the damper capsule extends into the recess volume. The total structural space required by the high-pressure fuel pump can thus be kept as small as possible.

In some embodiments, in the damper housing, there is at least one spacer sleeve for spacing the damper capsule apart from a damper housing wall, wherein the spacer sleeve extends into the recess volume. A spacer sleeve of said type may keep the damper capsule remote from the damper housing wall, to allow fuel to wash around the damper capsule. Such a spacer sleeve often also has a further function, specifically imparting a preload to weld seams that are provided for connecting two membranes that form the damper capsule. For example, at least one spacer sleeve may be arranged in the damper housing, though it is also possible for in each case one spacer sleeve to be arranged to both sides of the damper capsule. In some embodiments, multiple damper capsules and multiple spacer sleeves may be arranged in the damper housing.

In some embodiments, the spacer sleeve has radial recesses in order that fuel can flow through the spacer sleeve. In some embodiments, the damper capsule and/or the spacer sleeve are fastened exclusively in the damper housing. The fastening may be a force fit. For example, the spacer sleeves may be of resilient form, such that they can hold the damper capsule in position in the damper housing.

In some embodiments, the damper arrangement may be provided in a preassembly stage outside the pump housing of the high-pressure fuel pump, by virtue of the at least one damper capsule or the at least one spacer sleeve being fastened in the damper housing. Only thereafter is the entire damper arrangement then fastened as a module, for example by welding, to the pump housing of the high-pressure fuel pump. Thus, the damper arrangement can be preassembled as a called “cartridge damper” outside a main assembly line or even by a supplier. In this way, advantages can be achieved in the manufacture of the high-pressure fuel pump overall, for example by means of a reduced cycle time in the assembly process.

In some embodiments, one side of the damper housing is of open form, at least in the length of the diameter of the damper capsule or of the spacer sleeve. During the preassembly of the damper arrangement, a unit composed of damper capsules and spacer sleeves can be inserted laterally into said opening.

In some embodiments, the damper housing forms at least one connector geometry for the fastening of a fluid connector. The connector geometry extends in this case preferably parallel to the longitudinal axis of the damper housing. The fluid connector that can be fastened to said connector geometry may for example be a feed from a low-pressure region of the high-pressure fuel pump. It is however also possible for a connector or an outlet for a-called MPI system to be attached here. For example, a filter may also be formed in the fluid connector or in the connector geometry. The fluid connector and the connector geometry may for example be designed such that the fluid connector can be fastened to the connector geometry by simply being snapped on. It would however alternatively also be conceivable for the fluid connector to be welded to the connector geometry.

In some embodiments, the damper arrangement comprises a damper housing, a damper capsule, and a spacer sleeve, which serves for example to generate a preload of the damper capsule. The damper arrangement may optionally also comprise further components, such as for example further damper capsules, further spacer sleeves, a feed connector, a feed filter, a low-pressure connector for an MPI system, a seal, etc.

In some embodiments, the damper housing is formed as a unipartite deep-drawn part. Here, the damper housing may for example simultaneously form the receiving space for the damper capsule and the connector geometry for various fluid connectors. It is however alternatively also conceivable for the damper housing to be formed with a cover.

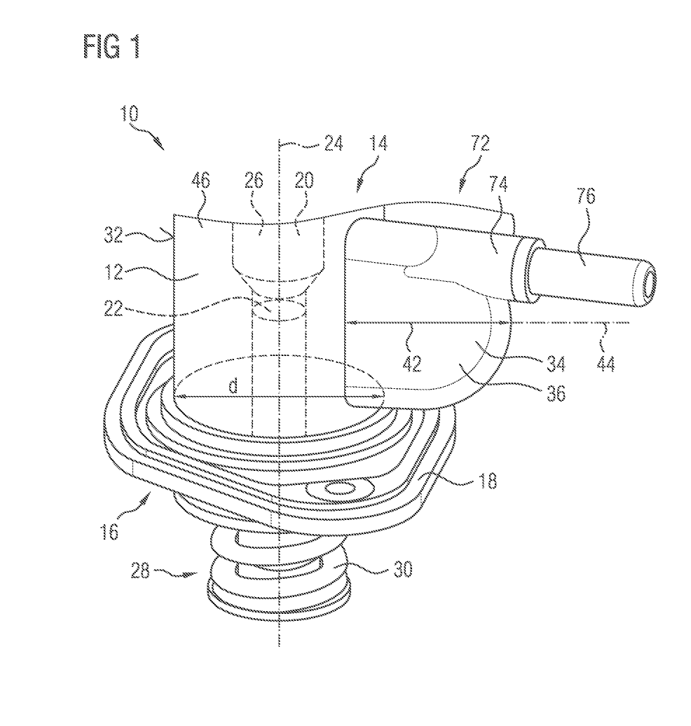

FIG. 1 is a perspective illustration of a high-pressure fuel pump 10 with which high pressure can be applied to a fuel, for example gasoline or diesel. The high-pressure fuel pump 10 has a pump housing 12 for accommodating elements of the high-pressure fuel pump 10. The pump housing 12 has a first end region 14 and a second end region 16.

In the embodiment shown in FIG. 1, on the pump housing 12 of the high-pressure fuel pump 10, there is arranged a flange 18, by means of which the pump housing 12 can be fastened to an engine block of an internal combustion engine.

Within the pump housing 12 there is arranged a housing bore 20 in which, during operation, a pump piston 22 moves in translational fashion along a movement axis 24 between the first end region 14 and the second end region 16. In the first end region 14, the housing bore 20 forms a pressure space 26 in which the fuel is compressed by the movement of the pump piston 22. Opposite the first end region 14, the pump housing 12 is arranged at the second end region 16 on a drive arrangement 28, which drives the pump piston 22 in its translational movement during operation. The drive arrangement 28 may for example be coupled to a camshaft of the internal combustion engine, on which the pump piston 22 is held for example by means of a spring 30.

The flange 18 is arranged on an outer wall region 32 of the pump housing 12, which outer wall region extends, parallel to the movement axis 24, between the first end region 14 and the second end region 16. Furthermore, a damper arrangement 34 is arranged on the outer wall region 32.

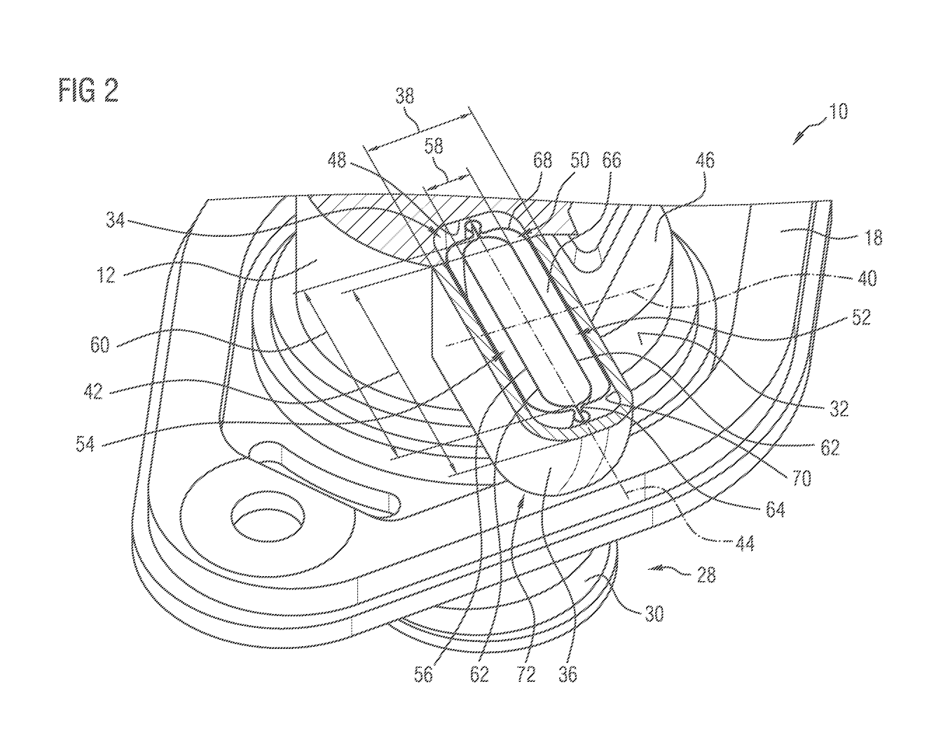

FIG. 1 shows only a damper housing 36 of the damper arrangement 34, wherein FIG. 2 is a cross-sectional illustration of the pump housing 12 with the damper arrangement 34, wherein an interior view of the damper arrangement 34 is illustrated in cut-away form.

As can be seen in FIG. 2, the damper housing 36 has a housing depth 38 which extends tangentially with respect to the outer wall region 32 along a depth axis 40. Furthermore, the damper housing 36 has a housing length 42 which extends, radially with respect to the movement axis 24, away from the outer wall region 32 along a longitudinal axis 44. As can be seen from FIG. 2, the housing length 42 is in this case larger than the housing depth 38. In particular, it can be seen that, in the present embodiment, the housing length 42 is approximately twice the size of the housing depth 38.

Therefore, the damper arrangement 34 is not, as has hitherto been known, provided on the first end region 14, that is to say on a head region of the high-pressure fuel pump 10, but is arranged laterally radially on the pump housing 12. In this way, it is possible, for the production of the pump housing 12, to use a bar material 46 which has a relatively small diameter d. This has hitherto not been possible, because it has been necessary to provide the structural space for the damper arrangement 34. With the new positioning of the damper arrangement 34, this is however now possible, such that the pump housing 12 can, overall, be manufactured at lower cost.

In FIG. 1, the pump housing 12 may be of such narrow diameter d that, in principle, the housing length 42, extending from the outer wall region 32, of the damper housing 36 is of equal size to the diameter d of the pump housing 12. For example, the pump housing 12 may be formed from a bar material 46 which has a diameter d<4 cm.

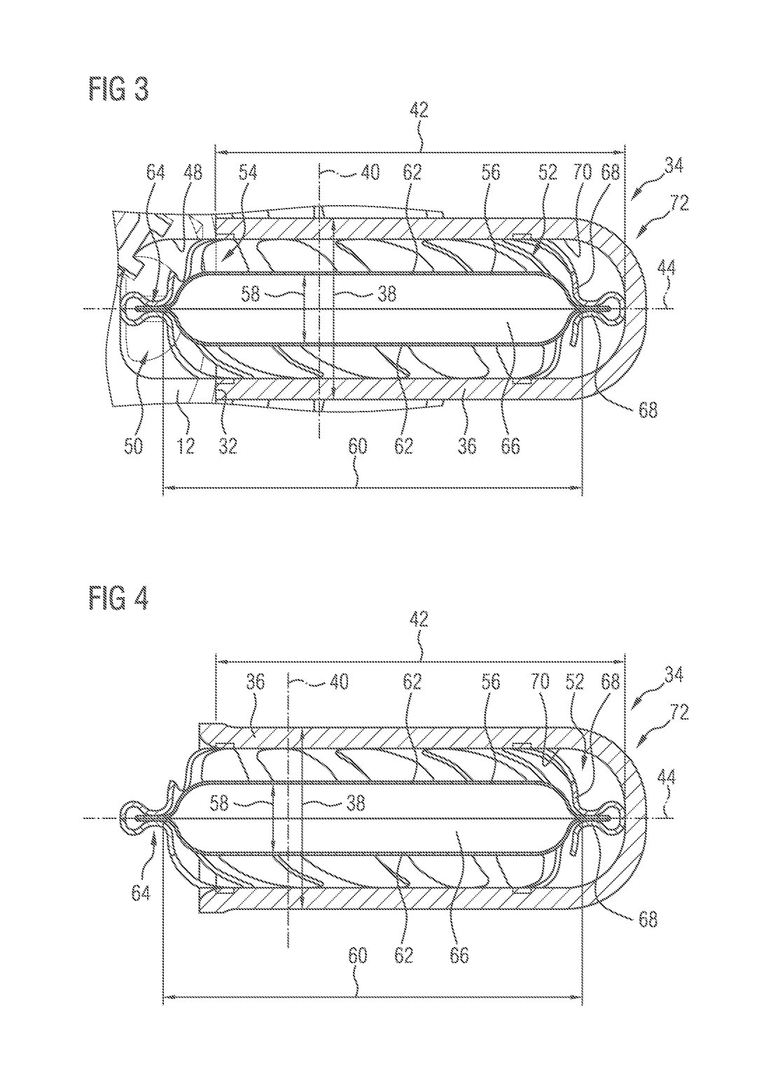

FIG. 3 is an enlarged illustration of the cross section corresponding to FIG. 2, in the region in which the damper housing 36 is fastened to the pump housing 12. In some embodiments, the pump housing 12 has, in the outer wall region 32, a recess 48 which is closed by the damper housing 36. The recess 48 thus forms a recess volume 50 which, together with a damper housing volume 52 formed by the damper housing 36, defines an overall damping volume 54. By virtue of the fact that a part of the overall damping volume 54 is arranged in the pump housing 12, specifically in the recess 48, it is furthermore possible for structural space to be saved in a radial direction of the high-pressure fuel pump 10. The major part of the overall damping volume 54 is however formed primarily by the damper housing volume 52, wherein the recess volume 54 amounts to at most one third of the overall damping volume 54.

Likewise arranged in the damper housing 36 is a damper capsule 56 which likewise extends radially away from the pump housing 12. Therefore, the damper capsule 56 has a capsule height 58, which extends tangentially with respect to the outer wall region 32, and a capsule length 60, which extends radially with respect to the movement axis 24. Here, the capsule length 60 is greater than the capsule height 58.

In some embodiments, the damper capsule 56 comprises two membranes 62, which are welded together at an edge region 64 and which thus, between them, enclose a gas volume 66. During operation, the damper housing 36 is filled with fuel. As soon as pressure peaks arise during the operation of the high-pressure fuel pump 10, which pressure peaks propagate further in the fuel, the fuel mass in the damper housing 36 increases and pushes the two membranes 62, which are deformable, toward one another, wherein the gas volume 66 is compressed. When the pressure peaks dissipate again, the gas volume 66 can expand again, and the membranes 62 can return to their original shape. By means of said gas volume 66, the pressure peaks may be attenuated, and the entire system may be protected against damage.

In the present embodiment, only one damper capsule 56 is provided in the damper housing 36, though it is also possible for multiple damper capsules 56 to be arranged in the damper housing 36.

In some embodiments, the damper capsule 56 is held spaced apart from a damper housing wall 70 by a spacer sleeve 68. Thus, on the one hand, the fuel can flow easily around the damper capsule 56, and on the other hand, the spacer sleeve 68 has the additional effect that it can impart a preload to the weld seam in the edge region 64, and thus stabilizes said weld seam. An exemplary spacer sleeve 68 is shown in a perspective illustration in FIG. 5. In some embodiments, the spacer sleeve 68 has radial recesses, such that the fuel can easily flow through it.

It can also be seen from FIG. 3 and FIG. 4 that the spacer sleeve 68 and the damper capsule 56 extend into the recess 48 in the pump housing 12. Nevertheless, said elements are fastened not in the recess 48 but only in the damper housing 36. This may for example be realized by means of a force fit by virtue of the spacer sleeve 68 being formed as a resilient element. In the embodiment shown in FIG. 3 and FIG. 4, in each case one spacer sleeve 68 is provided on both sides of the damper capsule 56 which is of resilient form, such that the spacer sleeves 68 hold the damper capsule 56 in position in the damper housing 36 by means of the spring force.

In some embodiments, the elements of the damper arrangement 34 are fastened exclusively to the damper housing 36 and not to the recess 48. It is thus possible for the damper arrangement 34 to be preassembled as a cartridge damper outside the high-pressure fuel pump 10 and then fastened at a later point in time to the pump housing 12.

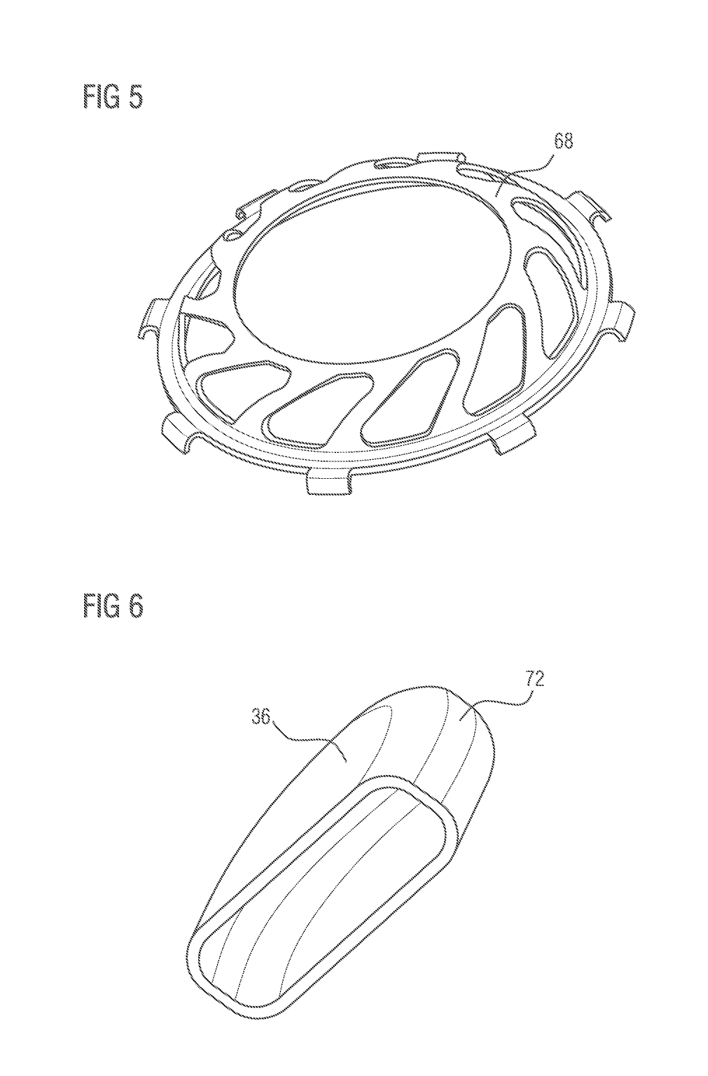

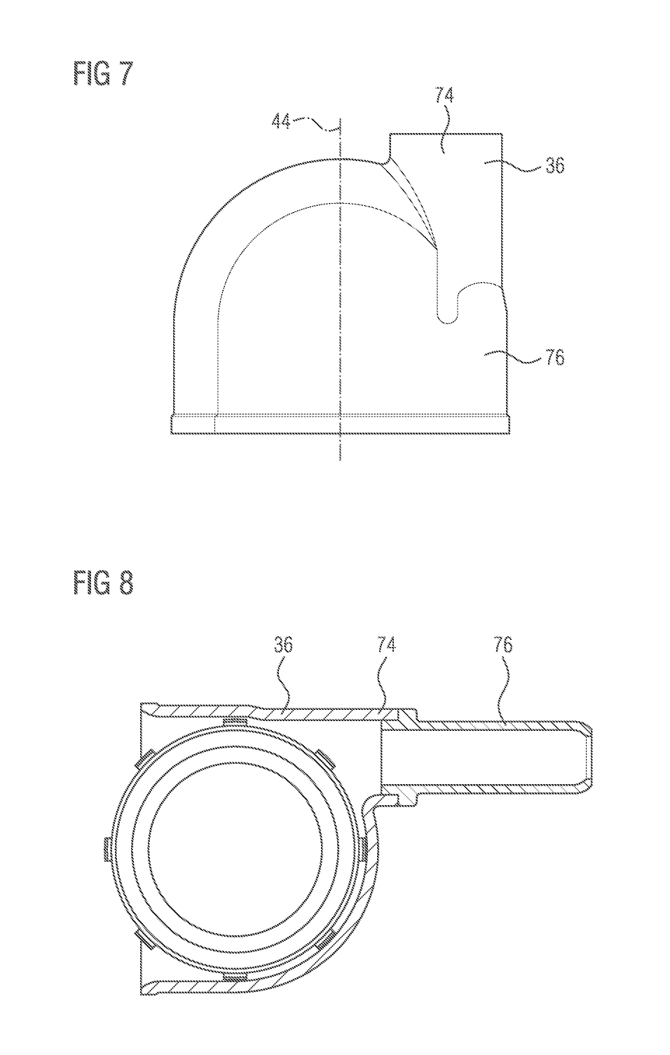

In order to make it possible for preassembly of the damper arrangement 34 outside the pump housing 12 to be realized in as simple a manner as possible, as shown in the perspective illustration in FIG. 6, one side of the damper housing 36 is open, such that a unit composed of at least one damper capsule 56 and at least one spacer sleeve 68 can be inserted therein. For example, the damper housing 36 may, as shown in FIG. 6, be formed as a unipartite deep-drawn part 72. In the case of this production method, it is also possible, as shown in FIG. 7 in the plan view of the damper housing 36, for a connector geometry 74 to be provided in an integral manner, to which connector geometry a fluid connector 76 can be fastened. The connector geometry 74 extends in this case preferably parallel to the longitudinal axis 44 of the damper housing 36.

FIG. 8 is a cross-sectional illustration of the damper arrangement 34 with a fluid connector 76 fastened thereto. The fluid connector 76 may for example be a feed from a low-pressure region, though may also be an outlet for, for example, an MPI system.

1. A fuel pump for applying pressure to a fuel in a fuel injection system, the fuel pump comprising:
a pump housing with a housing bore arranged between a first end region and a second end region, a pump piston movable in translation along a movement axis of the housing bore during operation, and an outer wall region extending parallel to the housing bore between the first end region and the second end region; and
a damper arrangement with a damper housing, wherein the damper housing and the outer wall region collectively delimit an overall damping volume;
wherein the damper housing has a housing depth extending tangentially with respect to the outer wall region along a depth axis;
the damper housing has a housing length extending radially with respect to the movement axis away from the outer wall region along a longitudinal axis; and
the housing length is greater than the housing depth.

2. The fuel pump as claimed in claim 1, wherein the housing length is at least twice the housing depth.

3. The fuel pump as claimed in claim 1, wherein:
the housing length is at least equal in size to a diameter d of the pump housing perpendicular to the movement axis; and
the pump housing comprises a bar material with a diameter d<4 cm.

4. The fuel pump as claimed in claim 1, wherein:
the pump housing includes a recess in the outer wall region;
the damper housing is arranged on the outer wall region so as to close off the recess in a flush manner;
a recess volume defined by the recess and a damper housing volume defined by the damper housing together define the overall damping volume; and
the recess volume comprises at most 1/3 of the overall damping volume.

5. The fuel pump as claimed in claim 1, further comprising a damper capsule arranged in the damper housing;
wherein the damper capsule has a capsule height extending tangentially with respect to the outer wall region and a capsule length extending radially with respect to the movement axis; and
the capsule length is greater than the capsule height.

6. The fuel pump as claimed in claim 4, wherein the damper capsule extends into the recess volume.

7. The fuel pump as claimed in claim 4, further comprising a spacer sleeve disposed in the damper housing for spacing the damper capsule apart from a damper housing wall;
wherein the spacer sleeve extends into the recess volume.

8. The fuel pump as claimed in claim 7, wherein the damper capsule and/or the spacer sleeve are fastened exclusively in the damper housing by a force fit.

9. The fuel pump as claimed in claim 1, wherein:
the damper housing forms a connector geometry for the fastening of a fluid connector; and
the connector geometry extends parallel to the longitudinal axis of the damper housing.

10. The fuel pump as claimed in claim 1, wherein the damper housing comprises a unipartite deep-drawn part.
